(19) United States
(12) Patent Application Publication
(10) Pub. No.: US 2016/0014846 A1
(43) Pub. Date: Jan. 14, 2016

(54) METHOD AND APPARATUS FOR SUPPLYING POWER TO A RADIANT HEATING ELEMENT

(71) Applicant: E.G.O. Elektro-Geraetebau GmbH, Oberderdingen (DE)

(72) Inventors: Thorsten Grunow, Stuttgart (DE); Jean Ehrhardt, Oberderdingen (DE)

(21) Appl. No.: 14/329,343

(22) Filed: Jul. 11, 2014

(51) Int. Cl. H05B 3/00; H05B 1/02

(52) U.S. Cl. CPC H05B 3/0071; H05B 1/0266

(57) ABSTRACT

In order to supply power to a radiant heating element, which is connected at a first connection, via a triac, to a first terminal of a supply voltage source and at a second connection, with a relay, to a second terminal of the supply voltage source, wherein an interference suppression capacitor is connected in parallel with the series circuit by the triac and the radiant heating element and a feedback circuit is connected between the triac and the radiant heating element, after disconnection of the radiant heating element from the second terminal, the interference suppression capacitor is now only connected to the second terminal via the feedback circuit. Depending on the time of the disconnection from the second terminal and the polarity of the supply voltage present at that time, the interference suppression capacitor is discharged via the feedback circuit, which results in discharge pulses at the feedback circuit which are taken as a signal that the radiant heating element is disconnected from the supply voltage source.

### TECHNOLOGICAL FIELD

The invention relates to a method for controlling or supplying power to a radiant heating element and to an apparatus which is designed and suitable for implementing this method.

### BACKGROUND

Normally, radiant heating elements as are used primarily in hobs beneath a glass-ceramic hob plate are supplied with power or controlled in accordance with a type of PWM method. This means that a radiant heating element is either connected to a supply voltage, to be precise to the mains supply voltage, or else is disconnected therefrom. EP 930805 B1 discloses one possibility of generating different total powers by virtue of differently interconnecting subregions of a radiant heating element. Conventional relays can be used for the switching.

### BRIEF SUMMARY

An object of the invention is to provide a method and an apparatus for supplying power to a radiant heating element, with which method and apparatus modem and versatile driving of a radiant heating element or power supply to a radiant heating element is possible whilst at the same time ensuring complete safety.

This problem is solved by a method and by an apparatus which is designed and is suitable for implementing this method. Advantageous and preferred configurations of the invention are subject matter of the further claims and will be explained in more detail below. Here, some of the features are only explained with reference to the method or only with reference to the apparatus. However, irrespective of this, it should be possible for the features to be able to apply independently both to the method and the apparatus. The wording of the claims is hereby incorporated in the description by express reference.

It is provided that the radiant heating element is connected at a first connection to a first terminal of a supply voltage source and at a second connection to a second terminal of the supply voltage source. This supply voltage source is generally the mains voltage. Depending on the number of radiant heating elements in an appliance or hob, it may be a single-phase, a two-phase or a three-phase mains connection. Advantageously, in this case the second terminal of the supply voltage can be ground and the first terminal can be phase. It is thus possible, therefore, for the radiant heating element to be operated with the full supply voltage from the supply voltage source during operation, to be precise either by virtue of clocking as described above or by virtue of burst fire control. In this case, the first connection to the first terminal of the supply voltage source is provided via an electronic switching means, wherein the electronic switching means is advantageously a semiconductor switch, particularly advantageously a triac. This electronic switching means replaces an electromechanical switch in the form of a relay or a bimetallic snap-action switch conventionally used for switching a radiant heating element. As a result, the switching can be performed more easily via electronic driving, for example it is also possible for a switching time to be set more accurately than with a relay, as a result of which, for example, the burst fire control is possible for the first time. An interference suppression capacitor is connected in parallel with the series circuit comprising the electronic switching means and the radiant heating element, i.e. via these two mentioned component parts, which interference suppression capacitor is used for suppressing interference in the form of reaction on the supply mains.

It should be noted here, that, for safety reasons, it should be possible to establish whether the radiant heating element is also actually disconnected or isolated from the supply voltage source. For this purpose, a feedback circuit is used which, in various exemplary embodiments, is advantageously connected between the electronic switching means and the radiant heating element. As will be explained below, this feedback circuit is used primarily to monitor or test correct operation of the electronic switching means or primarily disconnection or isolation of the radiant heating element from the supply voltage source effected by the electronic switching means. In addition, it can be used to identify safe switching of a further switching means. This feedback circuit is connected to the abovementioned second terminal or to ground of the supply voltage source.

The radiant heating element and the interference suppression capacitor are connected to the second terminal of the supply voltage source or to ground by means of a relay as the abovementioned further switching means. It is of course likewise possible for the radiant heating element and the interference suppression capacitor to be disconnected therefrom. This means that the electronic switching means is used for the abovementioned clocked operation or burst fire operation of the radiant heating element while the relay or switching means remains closed. Only once the operation of the radiant heating element has come to an end is the relay or switching means also opened in addition to the electronic switching means in order to achieve disconnection at all terminals. Safe disconnection of the relay or switching means is therefore of paramount importance and it should be possible to monitor this.

If the radiant heating element and the interference suppression capacitor are disconnected from the second terminal of the supply voltage source, i.e. if, once operation of the radiant heating element has taken place, the radiant heating element is intended to remain permanently switched off, and not only as part of PWM operation or burst fire operation, the interference suppression capacitor is now only connected to the second terminal of the supply voltage source or ground via the feedback circuit. Depending on the time of disconnection of the radiant heating element from the second terminal and the polarity of the supply voltage of the supply voltage source present at that time, the interference suppression capacitor is discharged via the feedback circuit. This discharging results in discharge pulses at the feedback circuit, which can then once again be taken as a signal that the radiant heating element and the interference suppression capacitor are actually disconnected from the supply voltage source, i.e. the relay as switching means has also actually opened. These discharge pulses at the feedback circuit can then be evaluated by a controller since they only last for a certain time, generally a few seconds. As soon as the voltage in the interference suppression capacitor has decayed, the pulses stop.

The so-called phantom pulses arise on the feedback circuit if the interference suppression capacitor is discharged via the circuit branch. If the hot plate relay were to open in a case which is rarely to be expected at the zero crossing of the supply voltage, the capacitor may be discharged already and no discharge pulses occur at all. This should be avoided.

A duration of the discharge pulses can be in the region of a few seconds, for example between 0.5 seconds (sec.) and 10 or 15 sec.

Advantageously, in some exemplary embodiments, it can be between 2 sec. and 10 sec. Such times can also be expected without any problems until a controller can be sure that the relay has actually opened as well and the radiant heating element has been disconnected safely from the supply voltage source.

Since the relay acts as switching means for safe disconnection of the radiant heating element from the supply voltage and is therefore a safety device, it is also possible in this way to safely establish or test after opening of the electronic switching means whether the relay as switching means has opened. If the relay has opened, the interference suppression capacitor is still on one side connected to the first terminal of the supply voltage source, but the other connection is only connected to the second terminal of the supply voltage source via the feedback circuit. In some exemplary embodiments, the switching time for opening of the relay or switching means is still selected such that a sufficient voltage level is present to be able to be sure to generate the discharge pulses as feedback signals. It is then possible, so to speak, to establish safe opening of the relay or switching means in two stages, namely by virtue of, during the first stage, the discharge pulses on the feedback circuit being established, with these discharge pulses then, in a second stage, fading away or decaying after the predetermined short time, which can again be established.

In an exemplary embodiment of the invention, an optocoupler is provided in the feedback circuit. The optocoupler is connected to a controller or to a microcontroller. Alternatively, a hardware circuit can be provided, for example an integrator which is implemented using hardware. Thus, as described above, it is possible to identify whether the relay as switching means has actually opened. The feedback circuit, in various exemplary embodiments, primarily has the task of testing whether the electronic switching means is in the switched-on state or not or of testing for functionality. The testing of the further switching means or relay is therefore, so to speak, of two-fold use.

In an exemplary embodiment of the invention, it is possible with the electronic switching means, in particular when it is a triac, to perform both the abovementioned clocking of the radiant heating element and likewise the electronic switching means can be operated with burst fire control. Thus, constant operation is possible with a power that can be set as desired, in which the radiant heating element has a slightly variable incandescent appearance which can permanently look that way or can have such a succession.

In one exemplary embodiment of the invention, in each case one zero crossing of the mains voltage is identified and the electronic switching means switch at the zero crossing so that load-free switching takes place, as a result of which EMC interference can be avoided. This identification of the zero crossing using a corresponding component part or identification means can also be mentioned for the switching of the further switching means or relay in order that the switching means or relay does not switch at the zero crossing in order that the abovementioned discharge pulses occur. This is also a two-fold use, so to speak. A circuit for identifying a zero crossing of the supply voltage is, in some exemplary embodiments, connected in parallel with the interference suppression capacitor or merely via the interference suppression capacitor. It can have a conventional design and can in particular contain an optocoupler.

In an exemplary embodiment of the invention, a single controller or a single microcontroller is used in order to drive a plurality of radiant heating elements. In this case, only one pin of the microcontroller is connected to the feedback circuit. In order to check the disconnection of a plurality of radiant heating elements from the supply voltage source via the abovementioned electronic switching means, all of the electronic component parts are switched off or are open, and then they are individually tested successively for their operation. It is thus possible to ensure that they are also working. In this case, in particular after the electronic switching means are switched on and off, a check is performed to ascertain whether the edge changes take place in the case of the feedback signal. If this edge change does not occur the first time, the operation is repeated several times. Feedback electronics are connected to diodes such that feedback only occurs in the positive half-cycle. If at that time a negative half-cycle of the supply voltage takes place, there is no feedback signal despite the electronic switching means working. Therefore, the driving is repeated after a wait time of a few half-cycles, in particular an uneven number of half-cycles such as three or five. If this still does not result in a positive operation test of the electronic switching means after a predetermined number of repetitions, a fault with this switching means is identified with corresponding consequences such as total disconnection, fault message, deactivation only of this switching means or the like.

In various exemplary embodiments, the test on the relay is only performed during operation of a hot plate, in particular during switch-off.

The apparatus for supplying power to a radiant heating element has a corresponding design and, in various exemplary embodiments, has the abovementioned component parts or assemblies. An exemplary embodiment of the apparatus can be easily understood from the figures.

A radiant heating element often has a so-called safety temperature limiter, also referred to as a rod-type thermostat, as is disclosed, for example, in EP 1926117 A2. The safety temperature limiter is intended to protect a glass-ceramic plate often used as hob plate from overheating, which could result in damage to the glass-ceramic plate. At a very high or maximum power of the radiant heating element at or close to the highest power setting, it may arise that the safety temperature limiter opens more often owing to the high temperature on the underside of the hob plate in too short a time. This can last for a relatively long period of time, also because a pot in position cannot draw off the supplied power as quickly. When the safety temperature limiter is open, however, safe disconnection or isolation of the radiant heating element from the supply voltage source can no longer be identified. To remedy this, after such an operation with a very high or maximum power of the radiant heating element, the power can be reduced considerably, for example down to 10% to 20% of the maximum power. Then, the radiant heating element is still in operation, on the one hand, but on the other hand now only produces a very small amount of power in comparison with previously, even in comparison with the heat still stored by the hob plate and emitted over a certain time. This reduction is therefore very considerable in comparison with the previous operation.

If the safety temperature limiter has cooled down sufficiently, for example after 30 sec. to 1 minute (min) or 2 min , it is safely closed again. Only then is it disconnected, which can now again be safely identified. The continued operation in the meantime of the radiant heating element for the limited short period of time at the very low power does not disrupt an operator; in the perception of such an operator, the hot plate with the radiant heating element is already disconnected.

These features and further features result from the claims and also from the description and the drawings, wherein the individual features are implemented each on their own or together in the form of sub-combinations in one embodiment of the invention and in different fields and can represent exemplary embodiments which are patentable in themselves, for which protection is claimed here. The subdivision of the application into subheadings and individual sections does not in any way restrict the statements made under these subheadings or in these sections in terms of general validity.

### BRIEF DESCRIPTION OF THE SEVERAL VIEWS OF THE DRAWINGS

Exemplary embodiments of the invention are illustrated schematically in the drawings and will be explained in more detail below. In the drawings:

FIG. 1 shows a simplified circuit diagram for a driver for supplying power to a radiant heating element, and

FIG. 2 shows a profile over time of an abovementioned feedback signal of the discharge pulses.

### DETAILED DESCRIPTION

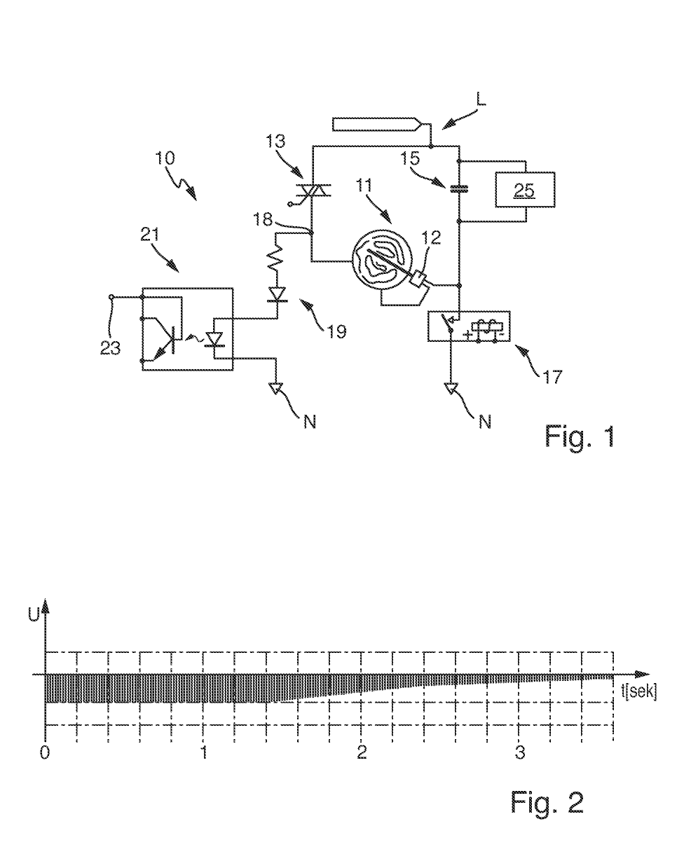

FIG. 1 shows a simplified illustration of a drive circuit as driver 10 for a radiant heating element 11, which can be built into a corresponding appliance in a conventional manner, in particular into a stove or hob. The radiant heating element 11 has a safety temperature limiter 12 which is known and is described above. The driver 10 has a triac 13 as abovementioned electronic switching means. With this triac 13, the radiant heating element 11 is connected to one terminal L of a supply voltage source, one of the phases, via the safety temperature limiter 12 by means of a controller (not illustrated). This can take place either in the manner of known PWM driving or in the manner of burst fire control for virtually constant operation of the radiant heating element, as previously described. The other connection of the radiant heating element 11 is connected to the other terminal N or a neutral conductor of the supply voltage source. In order to be able to achieve safe disconnection of the radiant heating element 11 after operation thereof, a hot-plate relay 17 is provided here. This is driven in a manner which is likewise not illustrated and ensures that, after the end of operation of the radiant heating element 11 or once an entire appliance or hob has been switched off, the radiant heating element 11 is disconnected at all terminals.

An interference suppression capacitor 15 is provided between the terminal L of the supply voltage source and the hot-plate relay 17 or in parallel with the series circuit comprising the radiant heating element 11 and the triac 13. This interference suppression capacitor is intended primarily to reduce or prevent disruptive reaction on the supply voltage source.

A connection 18 is provided between the radiant heating element 11 and the triac 13, to which connection an above-described feedback circuit 21 is connected via a diode 19. The other connection of the feedback circuit is connected to the second terminal N or the neutral conductor of the supply voltage source. The feedback circuit 21 has an optocoupler and in addition a connection 23 to a microcontroller (not illustrated) for evaluating the feedback signals. Alternatively a hardware circuit can be provided, for example an integrator.

During normal operation of the radiant heating element 11, the hot-plate relay 17 is closed. The power at the radiant heating element 11 is set at different switch-on times of the triac 13. The feedback circuit 21 is used in a known manner to test the triac. The operation of the safety temperature limiter 12 does not need to be described in any more detail here, with reference in this regard being made to the abovementioned EP 1926117 A2. The second function of the feedback circuit will be described below.

The interference suppression capacitor 15 is connected to the supply voltage during operation of the radiant heating element 11. If the hot-plate relay 17 is opened, it is now only connected to the second terminal N via the branch comprising radiant heating element 11, connection 18, diode 19 and feedback circuit 21. Depending on the time of opening of the hot-plate relay 17 and the phase of the supply voltage present at that time, the interference suppression capacitor 15 is discharged via this circuit branch. This causes so-called phantom pulses or discharge pulses at the feedback circuit 21. These discharge pulses are an indication that the contact of the hot-plate relay 17 is actually open. If the hot-plate relay 17 is opened at the zero crossing of the supply voltage the interference suppression capacitor 15 is discharged at this time and no phantom pulses or discharge pulses occur. Therefore, it is important not to open the hot-plate relay 17 at the zero crossing of the supply voltage, which is easily possible by means of the zero-crossing monitoring 25 of the supply voltage and matching driving of the hot-plate relay 17, as has been described above.

FIG. 2 shows the profile of these discharge pulses on the feedback circuit 21. Once the hot-plate relay 17 has been opened discharge pulses with the full amplitude arise after approximately 1.4 seconds. It is then possible to see how the voltage in the interference suppression capacitor 15 is no longer sufficient for the signal to be switched through completely. The discharge pulses become weaker and then stop after a few seconds. Owing to the use of these discharge pulses as an indicator of safe switching or opening of the hot-plate relay 17, no further circuitry measures are required. Thus, the feedback circuit 21 can advantageously even be used in other ways and overall both the triac 13 as electronic switching means and the hot-plate relay 17 as further switching means can be checked. It is even only necessary for the switching time of the opening of the hot-plate relay 17 to be such that a sufficient voltage level is still connected thereto for producing the discharge pulses. This can be achieved by the zero-crossing monitoring 25. Monitoring of the zero crossing of the supply voltage is also provided in order that the triacs 13 for the radiant heating element 11 can switch in a load-free manner and no EMC interference occurs.

For testing of the triac 13 and possible further triacs by means of the feedback circuit 21 as mentioned at the outset, first all of the triacs to be tested need to be switched off. There is therefore a wait time until there is no more feedback and all previous driving operations are complete. Then, in each case one triac is switched on and off in order to see whether an edge change occurs in the case of the feedback signal at the feedback circuit 21. If the edge changes do not occur, the operation is repeated several times until such an edge change occurs. The diode 19 serves the purpose of a feedback being provided only in the positive half-cycle of the supply voltage. If the test driving is performed when a negative half-cycle of the supply voltage occurs, there is no feedback signal, although the triac to be tested is operating properly. Therefore, this driving is repeated, after an uneven number of half-cycles, for example after three half-cycles. Then, necessarily, a half-cycle of another polarity is present, a positive half-cycle by way of example. Now, the feedback circuit 21 can establish an edge change when the triac is operating and this triac is classified as operational. Once all of the triacs have been tested successively, the cooking operation is continued again. The triacs are tested when the corresponding hot-plate relays are closed.

Alternatively, the triacs can also be tested by switching on and waiting for the feedback signals. This is then independent of the hot-plate relays.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for supplying power to a radiant heating element,
wherein said radiant heating element has a first connection being connected to a first terminal of a supply voltage source and has a second connection being connected to a second terminal of said supply voltage source,
wherein said first connection to said first terminal is made via an electronic switching means, said radiant heating element and said electronic switching means forming together a series circuit,
wherein an interference suppression capacitor is connected in parallel with said series circuit,
wherein a feedback circuit is connected between said electronic switching means and said radiant heating element and is connected to said second terminal or to ground,
wherein said radiant heating element and said interference suppression capacitor are connected to said second terminal of said supply voltage source or to said ground and are disconnected therefrom by means of a relay,
wherein after disconnection of said radiant heating element and said interference suppression capacitor from said second terminal, said interference suppression capacitor is now only connected to said second terminal via said feedback circuit and, depending on the time of disconnection from said second terminal and said polarity of said supply voltage of said supply voltage source present at that time, said interference suppression capacitor is discharged via said feedback circuit, and
wherein said discharging results in discharge pulses at said feedback circuit, and wherein said discharge pulses are taken as a signal that said radiant heating element and said interference suppression capacitor are disconnected from said supply voltage source.

2. The method as claimed in claim 1, wherein said pulse time is between 0.5 seconds and 15 seconds.

3. The method as claimed in claim 2, wherein said pulse time is between 2 seconds and 10 seconds.

4. The method as claimed in claim 1, wherein a switching time of said relay at said second terminal for disconnection is such that said relay has a sufficient voltage level for feedback signals to be generated by said interference suppression capacitor at said feedback circuit, wherein, a zero crossing of said supply voltage is monitored.

5. The method as claimed in claim 1, wherein an optocoupler with a connection to a controller or a microcontroller is provided in said feedback circuit.

6. The method as claimed in claim 1, wherein, during driving of a plurality of said radiant heating elements, a single controller or a single microcontroller is provided, and only one port of said single controller or said single microcontroller is connected to said feedback circuit at a controller or at a microcontroller, wherein in order to check disconnection of said plurality of radiant heating elements from said supply voltage source, all of said electronic switching means are switched off or opened and then are tested individually and successively for their operation.

7. An apparatus for implementing said method as claimed in claim 1, wherein said radiant heating element is connectable at a first connection to a first terminal of a supply voltage source and at a second connection to a second terminal of the supply voltage source,
wherein said first connection to said first terminal is made via an electronic switching means, said radiant heating element and said electronic switching means forming together a series circuit,
wherein an interference suppression capacitor is connected in parallel with said series circuit,
wherein a feedback circuit is connected between said electronic switching means and said radiant heating element and is connected to said second terminal or to ground,
said radiant heating element and said interference suppression capacitor are connectable to said second terminal of said supply voltage source or to said ground by means of a relay, and
after disconnection of said radiant heating element and said interference suppression capacitor from said second terminal, said interference suppression capacitor is now only connected to said second terminal via said feedback circuit for discharge of said interference suppression capacitor via said feedback circuit.

8. The apparatus as claimed in claim 7, wherein an optocoupler with a connection to a controller or a microcontroller is provided in said feedback circuit.
